(19) United States
(12) Patent Application Publication
(10) Pub. No.: US 2024/0185064 A1
(43) Pub. Date: Jun. 6, 2024

(54) LEARNING APPARATUS, METHOD, NON-TRANSITORY COMPUTER READABLE MEDIUM AND INFERENCE APPARATUS

(71) Applicant: KABUSHIKI KAISHA TOSHIBA, Tokyo (JP)

(72) Inventors: Tenta SASAYA, Tokyo (JP); Takashi WATANABE, Yokohama Kanagawa (JP); Toshiyuki ONO, Kawasaki Kanagawa (JP)

(73) Assignee: KABUSHIKI KAISHA TOSHIBA, Tokyo (JP)

(21) Appl. No.: 18/458,209

(22) Filed: Aug. 30, 2023

(30) Foreign Application Priority Data
Dec. 1, 2022 (JP) 2022-193028

(51) Int. Cl. G06N 3/08; G06N 3/045

(52) U.S. Cl. CPC G06N 3/08; G06N 3/045

(57) ABSTRACT

According to one embodiment, a learning apparatus includes processing circuitry. The processing circuitry generates a first converted feature values and a second converted feature values by stochastically converting at least one of first feature values and second feature values. The processing circuitry calculates a first loss related to similarity between the first converted feature values and the second converted feature values. The processing circuitry obtains a first processing result by processing based on one or more third parameters with respect to the first converted feature values. The processing circuitry updates a parameter of at least one of the first parameters and the third parameters such that a value based on the first loss and a second loss calculated from the first processing result and a label is minimized.

### CROSS-REFERENCE TO RELATED APPLICATION

This application is based upon and claims the benefit of priority from Japanese Patent Application No. 2022-193028, filed Dec. 1, 2022, the entire contents of which are incorporated herein by reference.

### FIELD

Embodiments described herein relate generally to a learning apparatus, a method, a non-transitory computer readable medium and an inference apparatus.

### BACKGROUND

The public data set used for machine learning can be said to be ideal data that does not include unnecessary information (for example, noise or a background image), but the actual data often includes unnecessary information other than the target. Among them, a situation is assumed in which desired information included in actual data is almost filled with unnecessary information, that is, a situation in which a desired signal is buried in noise, because of a request for short-time measurement or because data itself to be identified is weak.

In a case where a trained model trained with ideal data is used for inference of processing target data including such unnecessary information, there is a possibility sufficient performance cannot be obtained. In addition, although it is conceivable to remove unnecessary information in advance, there is a possibility that data after removing unnecessary information does not necessarily lead to improvement in performance because there is an artifact such as blurring. In addition, another method is to use information from neural network trained with data that does not include unnecessary information, and train data that includes unnecessary information in another neural network, but it may be difficult to obtain data that does not include unnecessary information.

### BRIEF DESCRIPTION OF DRAWINGS

FIG. 1 is a block diagram illustrating a learning apparatus according to a first embodiment.

FIG. 2 is a flowchart illustrating a first training example of the learning apparatus according to the first embodiment.

FIG. 3 is a flowchart illustrating a second training example of the learning apparatus according to the first embodiment.

FIG. 4 is a conceptual diagram illustrating details of parameter update processing of the learning apparatus according to the first embodiment.

FIG. 5 is a flowchart illustrating a third training example of the learning apparatus according to the first embodiment.

FIG. 6 is a block diagram illustrating an inference apparatus according to a second embodiment.

FIG. 7 is a flowchart illustrating an inference processing of the inference apparatus according to the second embodiment.

FIG. 8 is a diagram illustrating an example of a hardware configuration of the learning apparatus and the inference apparatus according to the embodiments.

### DETAILED DESCRIPTION

In general, according to one embodiment, a learning apparatus includes processing circuitry. The processing circuitry extracts first feature values from input data by processing based on one or more first parameters. The processing circuitry extracts second feature values from the input data by processing based on one or more second parameters different from the first parameters. The processing circuitry generates a first converted feature values and a second converted feature values by stochastically converting at least one of the first feature values and the second feature values. The processing circuitry calculates a first loss related to similarity between the first converted feature values and the second converted feature values. The processing circuitry obtains a first processing result by processing based on one or more third parameters with respect to the first converted feature values, the one or more third parameters being different from the first parameters and the second parameters. The processing circuitry updates a parameter of at least one of the first parameters and the third parameters such that a value based on the first loss and a second loss calculated from the first processing result and a label is minimized.

Hereinafter, a learning apparatus, a method, a non-transitory computer readable medium, and an inference apparatus according to the embodiments will be described in detail with reference to the drawings. Note that, in the following embodiments, portions denoted by the same reference numerals perform the same operation, and redundant description will be appropriately omitted.

### First Embodiment

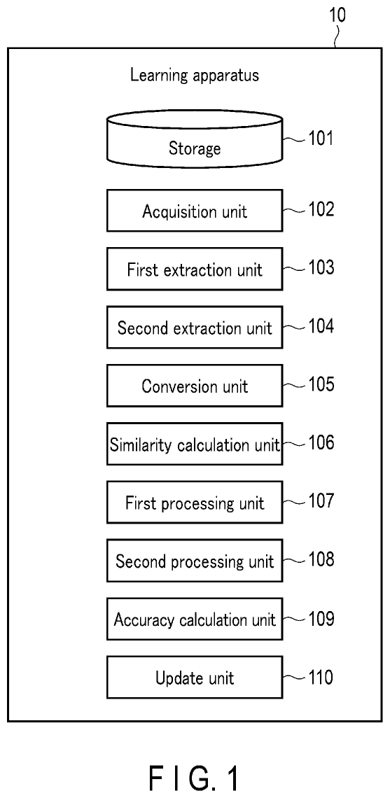

A learning apparatus according to a first embodiment will be described with reference to a block diagram of FIG. 1.

The learning apparatus 10 according to the first embodiment includes a storage 101, an acquisition unit 102, a first extraction unit 103, a second extraction unit 104, a conversion unit 105, a similarity calculation unit 106, a first processing unit 107, a second processing unit 108, an accuracy calculation unit 109, and an update unit 110.

The storage 101 stores a machine learning model, input data, labels (ground truth data), and the like.

The acquisition unit 102 acquires input data from the storage 101 or externals. The input data is assumed to be multidimensional data. The multidimensional data is, for example, an image. Note that the input data may be time-series data such as speech and a sensor value. The input data includes unnecessary information in addition to the information to be processed. Examples of the unnecessary information include noise, a background image, information having close characteristics to a processing target, and distortion and fluctuation generated at the time of or after measurement of multidimensional data. Specifically, if the multidimensional data is an image, an image with noise is assumed as the input data.

The first extraction unit 103 receives input data from the acquisition unit 102, and extracts a first feature values from the input data by processing based on one or more parameters. For example, if the input data is an image, the first extraction unit 103 extracts the first feature values by executing processing on the input data using a neural network as a machine learning model. In addition, the parameter is, for example, a weighting factor or a bias.

The second extraction unit 104 receives the same input data from the acquisition unit 102, and extracts a second feature value from the same input data by processing based on one or more parameters different from those of the first extraction unit 103. Similarly to the first extraction unit 103, the second extraction unit 104 also executes processing on input data using a neural network as a machine learning model, and extracts the second feature values. Here, the first extraction unit 103 and the second extraction unit 104 may use different networks, and for example, at least one of a network weighting factor, the number of network layers, the number of nodes, and architecture may be different from each other.

The conversion unit 105 receives the first feature values from the first extraction unit 103 and the second feature value from the second extraction unit 104. The conversion unit 105 stochastically converts at least one of the first feature values and the second feature value to generate first converted feature values and second converted feature values. Note that, in the processing of the conversion unit 105, any one of the first feature values and the second feature value may be stochastically converted to be different values from each other, and thus the converted feature values for which the conversion processing is not executed may be the same value as the feature values. That is, if the conversion processing is stochastically executed for the first feature values and the conversion processing is not executed for the second feature value, the second feature value and the second converted feature values have the same value.

The similarity calculation unit 106 receives the first converted feature values and the second converted feature values from the conversion unit 105, and calculates the first loss regarding the similarity between the first converted feature values and the second converted feature values.

The first processing unit 107 receives the first converted feature values from the conversion unit 105. The first processing unit 107 executes processing based on one or more parameters different from those of the first extraction unit 103 and the second extraction unit 104 on the first converted feature values to obtain a first processing result. The first processing result is assumed to be a processing result of a task of the machine learning model used by the first extraction unit 103. For example, if the task of the machine learning model is a classification task, a classification result output using an activation function such as a fully-connected layer or a softmax function is the first processing result. Note that the task of the machine learning model is not limited to classification, and may be any task such as object detection and segmentation.

The second processing unit 108 receives the second converted feature values from the conversion unit 105. The second processing unit 108 executes processing based on one or more parameters different from those of the first extraction unit 103, the second extraction unit 104, and the first processing unit 107 on the second converted feature values, and obtains a second processing result. The second processing result is also a processing result for the same task as the first processing result, and is a processing result of the task of the machine learning model used by the second extraction unit 104.

The accuracy calculation unit 109 receives the first processing result from the first processing unit 107 and the second processing result from the second processing unit 108. The accuracy calculation unit 109 calculates the second loss from the first processing result and the label. The accuracy calculation unit 109 calculates the third loss from the second processing result and the label. The second loss and the third loss are losses related to tasks of the machine learning model, such as classification loss.

The update unit 110 receives the first loss from the similarity calculation unit 106 and the first processing result from the first processing unit 107. The update unit 110 updates at least one parameter of the first extraction unit 103 and the first processing unit 107 so that a value based on the first loss and the second loss calculated from the first processing result and the label is minimized.

In addition, the update unit 110 receives the second processing result from the second processing unit 108. The update unit 110 updates at least one parameter of the second extraction unit 104 and the second processing unit 108 so that a value based on the third loss calculated from the second processing result and the label is minimized.

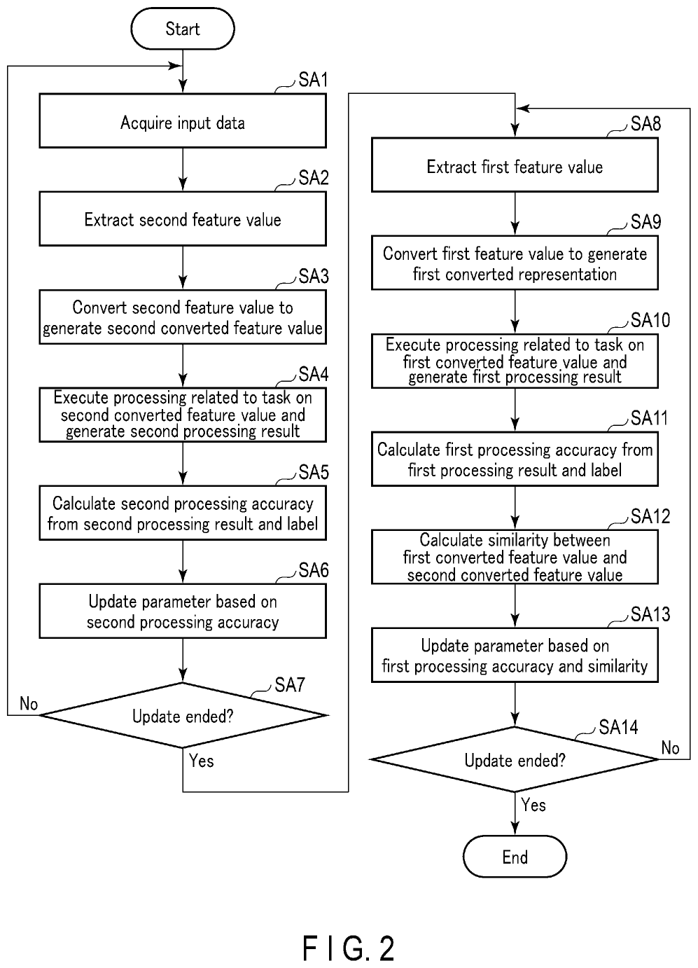

Next, a first training example of the learning apparatus 10 according to the present embodiment will be described with reference to the flowchart of FIG. 2. In the first training example, training of the machine learning model used in the second extraction unit 104 and the second processing unit 108 ends first. Then, training of the machine learning model used in the first extraction unit 103 and the first processing unit 107 is performed.

In step SA1, the acquisition unit 102 acquires the input data. As described above, the input data is data with unnecessary information (noise).

In step SA2, the second extraction unit 104 extracts the second feature value from the input data.

In step SA3, the conversion unit 105 converts the second feature value to generate the second converted feature values. In the conversion processing of the conversion unit 105, for example, processing of replacing at least one element of the second feature value selected by a random number with a predetermined value such as DropOut, StochasticDepth, DropPath, DropBlock, or DropConnect may be applied. As another example of the conversion processing, the conversion unit 105 may add or multiply the second feature value and a pattern generated based on a random number, such as Variational DropOut and ZoneOut.

In step SA4, the second processing unit 108 executes processing related to the task on the second converted feature values and generates the second processing result.

In step SA5, the accuracy calculation unit 109 calculates a second processing accuracy (third loss) from the second processing result and the label.

In step SA6, the update unit 110 updates the parameter of at least one of the second extraction unit 104 and the second processing unit 108 based on the second processing accuracy.

In step SA7, the update unit 110 determines whether or not the parameter update has ended. Regarding whether or not the update of the parameter has ended, the update unit 110 may determine that the update of the parameter has ended, for example, in a case where the update processing is executed a predetermined number of times, or may determine that the update of the parameter has ended in a case where the value based on the second loss is equal to or less than the threshold value. In a case where the update of the parameter has ended, the process proceeds to step SA8. In a case where the update of the parameter has not ended, the process returns to step SA1, and a similar process is repeated.

In step SA8, the first extraction unit 103 extracts the first feature values from the input data.

In step SA9, the conversion unit 105 converts the first feature values to generate the first converted feature values. Note that the conversion unit 105 may generate the first converted feature values by weighted averaging of the first feature values and the second feature value.

In step SA10, the first processing unit 107 executes processing related to the task on the first converted feature values and generates the first processing result.

In step SA11, the accuracy calculation unit 109 calculates a first processing accuracy (second loss) from the first processing result and the label.

In step SA12, the similarity calculation unit 106 calculates a loss regarding the similarity between the first converted feature values and the second converted feature values (first loss).

In step SA13, the update unit 110 updates the parameter of at least one of the first extraction unit 103 and the first processing unit 107 based on the first loss and the second loss.

In step SA14, the update unit 110 determines whether or not the parameter update has ended. The end determination related to the parameter update is similar to step SA7. In a case where the update of the parameter has ended, the process ends. In a case where the update of the parameter has not ended, the process returns to step SA8, and a similar process is repeated.

Note that either the process of step SA11 or the process of step SA12 may be executed first.

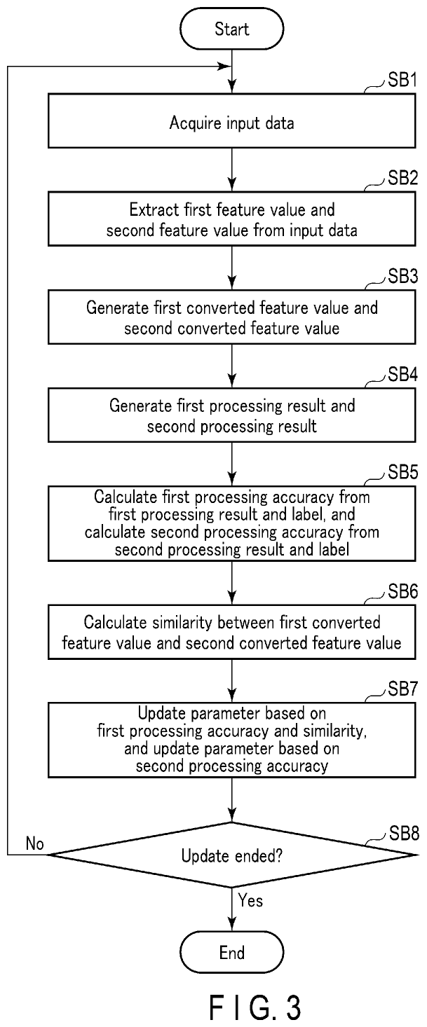

Next, a second training example of the learning apparatus 10 according to the present embodiment will be described with reference to the flowchart of FIG. 3. In the second training example, the machine learning model used in the first extraction unit 103 and the first processing unit 107 and the machine learning model used in the second extraction unit 104 and the second processing unit 108 are trained in parallel.

In step SB1, the acquisition unit 102 acquires the input data.

In step SB2, the first extraction unit 103 extracts the first feature values from the input data, and the second extraction unit 104 extracts the second feature value from the input data.

In step SB3, the conversion unit 105 generates the first converted feature values and the second converted feature values. Note that the conversion unit 105 may generate the first converted feature values or the second converted feature values by weighted averaging of the first feature values and the second feature value.

In step SB4, the first processing unit 107 generates the first processing result based on the first converted feature values, and the second processing unit 108 generates the second processing result based on the second converted feature values.

In step SB5, the accuracy calculation unit 109 calculates a loss regarding the first processing accuracy (second loss) from the first processing result and the label, and calculates a loss regarding the second processing accuracy (third loss) from the second processing result and the label.

In step SB6, the similarity calculation unit 106 calculates a loss regarding the similarity between the first converted feature values and the second converted feature values (first loss).

In step SB7, the update unit 110 updates the parameter of at least one of the first extraction unit 103 and the first processing unit 107 based on the first loss and the second loss. In parallel, the update unit 110 updates the parameter of at least one of the second extraction unit 104 and the second processing unit 108 based on the second processing accuracy.

In step SB8, the update unit 110 determines whether or not the parameter update has ended. In a case where the update of the parameter has ended, the process ends. In a case where the update of the parameter has not ended, the process returns to step SB1, and a similar process is repeated. In this manner, training time can be reduced by training the machine learning models in parallel.

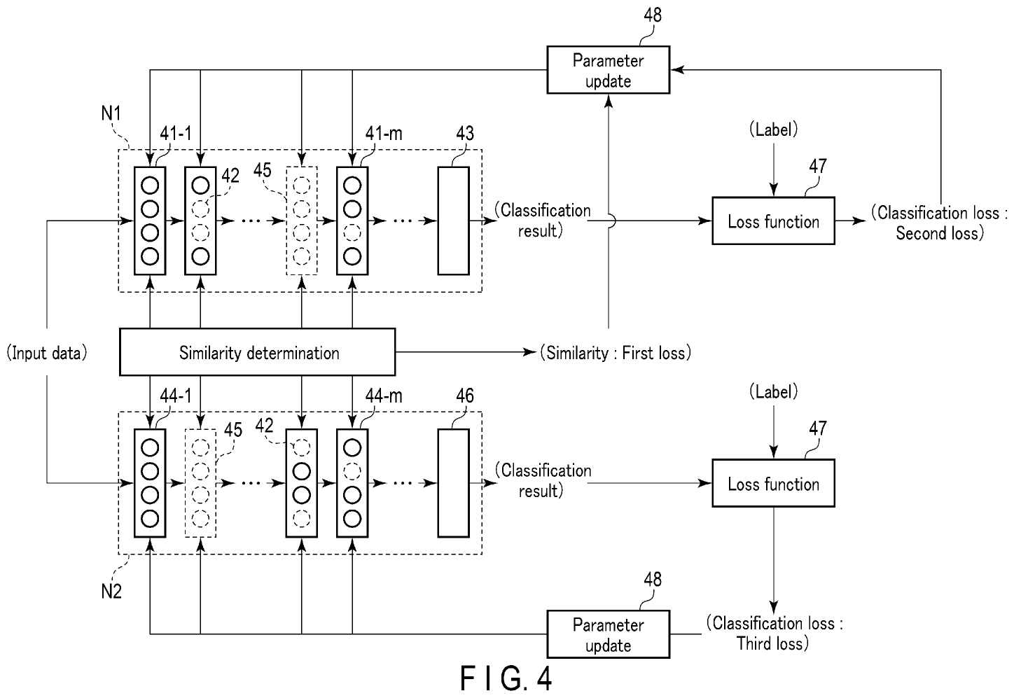

Next, with reference to a conceptual diagram in FIG. 4, details of parameter update processing of the learning apparatus 10 will be described.

FIG. 4 is a configuration example of a machine learning apparatus to be trained by the learning apparatus 10. Here, an example in which the first extraction unit 103 uses a convolution layer 41 will be described. The first processing unit 107 uses the output layer 43 such as a softmax function for performing a task. One or more convolution layers 41 (41-1 to 41-m, m is a positive number of 2 or more) and one output layer 43 constitute a first network N1. That is, one or more parameter groups processed by each of the first extraction unit 103 and the first processing unit 107 correspond to parameters of the first network N1.

Similarly, an example in which the second extraction unit 104 uses a convolution layer 44 will be described. The second processing unit 108 uses the output layer 46 for performing a task. One or more convolution layers 44 (44-4 to 44-m, m is a positive number of 2 or more) and one output layer 46 constitute a second network N2. That is, one or more parameter groups processed by the second extraction unit 104 and the second processing unit 108 correspond to the parameters of the second network N2.

Note that, for convenience of description, in each of the first extraction unit 103 and the second extraction unit 104 illustrated in FIG. 4, only the convolution layer is illustrated, and the activation function, the normalization layer, the fully-connected layer, the layer for executing the stochastic conversion, and the like used in the convolutional neural network are omitted. However, in practice, it is assumed that an architecture of a network used in a desired task including layers not illustrated is used.

The first extraction unit 103 executes convolution processing in each layer of the convolution layer 41 and extracts first feature values. The conversion unit 105 applies conversion processing to each convolution layer 41. Here, DropOut is applied to one or more convolution layers 41 as the conversion processing. By applying DropOut to the convolution layer 41, the conversion unit 105 inactivates (invalidates) one or more randomly selected nodes 42 among a plurality of nodes in a certain convolution layer 41, for example. As processing, a convolution process is performed in each node of one convolution layer 41, and an output from each node is an input to the next convolution layer 41. However, each node is randomly selected, and an output value of the selected node is multiplied by 0, so that the node 42 is inactivated. Therefore, for example, for the first feature values to which the conversion processing is applied, an output from the convolution layer 41 including the node 42 dropped out corresponds to the first converted feature values.

The conversion unit 105 may combine and apply the conversion processing. For example, the DropBlock may be applied to the convolution layer 41 in addition to the DropOut. In this case, each convolution layer 41 is assumed to be a convolution block having a shortcut structure. By performing DropBlock, one or more convolution layers 45 randomly selected among the plurality of convolution layers 41 are inactivated (invalidated). That is, the output of the convolution layer 41 immediately before the layer subjected to the DropBlock is input to the convolution layer 41 next to the layer subjected to the DropBlock.

On the other hand, the conversion processing by the conversion unit 105 may be similarly applied to the second network N2 in the second extraction unit 104 and the second processing unit 108. The second feature value to which the conversion processing is applied corresponds to the second converted feature values.

The similarity calculation unit 106 calculates the similarity of the feature values extracted in the convolution layer 41 of the first network N1 and the convolution layer 44 of the second network N2 with respect to input data with noise. Specifically, for example, a difference between the first feature values extracted in the first layer of the first network N1 and the second feature value extracted in the first layer of the second network N2 is calculated, and a difference is similarly calculated in each layer. The similarity calculation unit 106 calculates a mean square error (MSE) of the differences calculated in the respective layers as a loss related to the similarity of the feature values (first loss).

Note that the first feature values and the second feature value to be compared for calculating the similarity are not limited to the outputs of the convolution layer 41 and the convolution layer 44. For example, if a pooling layer is arranged after a certain convolution layer in each of the first network N1 and the second network N2, the similarity calculation unit 106 may calculate the similarity between the outputs from the pooling layers. That is, the similarity calculation unit 106 may calculate similarity between outputs from corresponding layers of the network architecture.

Furthermore, the first processing unit 107 generates, as a first processing result, a classification result output via the output layer 43 for the first converted feature values obtained by forward propagating the input data in the first network N1. Thereafter, the accuracy calculation unit 109 calculates a difference between the label and the classification result, for example, using a cross entropy error as a loss function 47, and obtains a classification loss (second loss).

The second processing unit 108 generates, as a second processing result, a classification result output via the output layer 46 for the second converted feature values obtained by forward propagating the input data in the second network N2. Thereafter, the accuracy calculation unit 109 calculates a difference between the label and the classification result using a cross entropy error as a loss function 47, and obtains a classification loss (third loss).

The update unit 110 executes a parameter update 48 of the first network N1 using the first loss and the second loss, and executes a parameter update 48 of the second network N2 using the third loss.

Note that the first processing unit 107 and the second processing unit 108 may have different configurations. At this time, it is also assumed that dimensions of feature values are different between the first network N1 and the second network N2. Therefore, in a case where the dimensions of the feature values are different, the conversion unit 105 may execute processing of matching the dimensions of the first feature values and the second feature value.

In the parameter update 48, the machine learning model is trained such that the intermediate features of the first network N1 and the second network N2 are close to each other by considering the first loss. In particular, as the stochastic conversion processing such as DropOut is applied to each network, even in a case where the same input data is processed, there is fluctuation in the obtained feature values (difference in feature values). As a result of such training, a trained model robust against noise of input data can be generated.

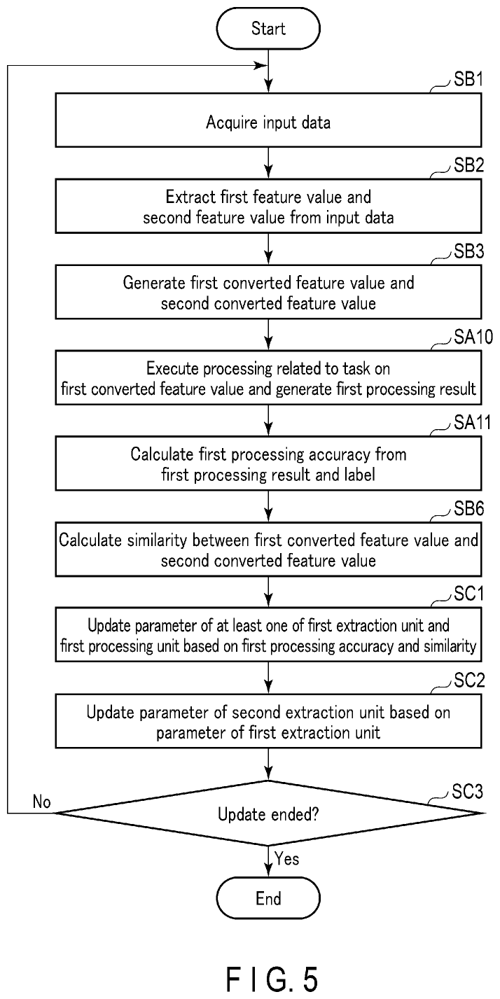

Next, a third training example of the learning apparatus 10 will be described with reference to the flowchart of FIG. 5.

The processing of step SA10, step SA11, step SB1 to step SB3, and step SB6 is similar to the above-described processing.

In step SC1, the update unit 110 updates the parameter of at least one of the first extraction unit 103 and the first processing unit 107 based on the first loss regarding the similarity and the second loss regarding the processing accuracy.

In step SC2, the update unit 110 updates the parameter of the second extraction unit 104 based on the updated parameter of the first extraction unit 103. Specifically, the update unit 110 may copy, for example, the parameter of the first extraction unit 103 at the first time point as the parameter of the second extraction unit 104. In addition, the update unit 110 may set a moving average or a weighted average of the parameter of the first extraction unit 103 at the first time point and the parameter of the first extraction unit 103 at the second time point earlier than the first time point as the parameter of the second extraction unit 104.

In step SC3, the update unit 110 determines whether or not the update of the first extraction unit 103 and the first processing unit 107 has ended. The update end condition is similar to the processing illustrated in FIGS. 2 and 3. If the update has ended, the process ends, and if the update has not ended, the process returns to step SB1 and a similar process is repeated.

As illustrated in the flowchart of FIG. 5, the parameter of the second extraction unit 104 can be updated based on the parameter update result of the first extraction unit 103 without requiring the classification results from the second extraction unit 104 and the second processing unit 108. For example, even if the same parameter value is temporarily obtained in the first network N1 and the second network N2 by copying the parameter value, since the stochastic conversion is performed by the conversion unit 105, it is possible to cause fluctuation of the parameter value between the networks in a case where the training of the network proceeds, to perform processing similarly to the first training example and the second training example, and to reduce the calculation cost.

Note that the first extraction unit 103 and the second extraction unit 104 may calculate the first feature values and the second feature value, respectively, after performing preprocessing on the input data. For example, in a case where the input data is an image, affine transformation and pixel value transformation of the image may be executed as preprocessing. In addition, in a case where the input data is speech data, time shift, pitch conversion, scale conversion, and the like may be executed as preprocessing.

In addition, the input data input to the first extraction unit 103 and the second extraction unit 104 is not limited to the same data, and may be two pieces of data obtained by acquiring the same target under different conditions. Furthermore, data after data argumentation such as rotation, division, and inversion can be executed on the input data may be used as the input data.

According to the first embodiment described above, with respect to input data with noise, for example, the first feature values and the second feature value obtained by feature representation extraction of two neural networks are stochastically converted by DropOut or the like, and the first converted feature values and the second converted feature values are generated. Further, a first loss related to the similarity between the first converted feature values and the second converted feature values and a second loss related to processing accuracy which is a difference between the processing result of the task based on the first converted feature values and the label are calculated. At least one parameter of the first extraction unit and the first processing unit is updated using the first loss and the second loss.

As a result, by performing training so that the feature values obtained in the two networks are close to each other, in other words, to suppress fluctuation of the feature values, it is possible to generate, without using noise-free data that is difficult to acquire, a trained model robust to input data with noise, in other words, a trained model capable of processing data with unnecessary information with high accuracy.

### Second Embodiment

In a second embodiment, it is assumed that inference processing is performed using the trained model trained in the first embodiment.

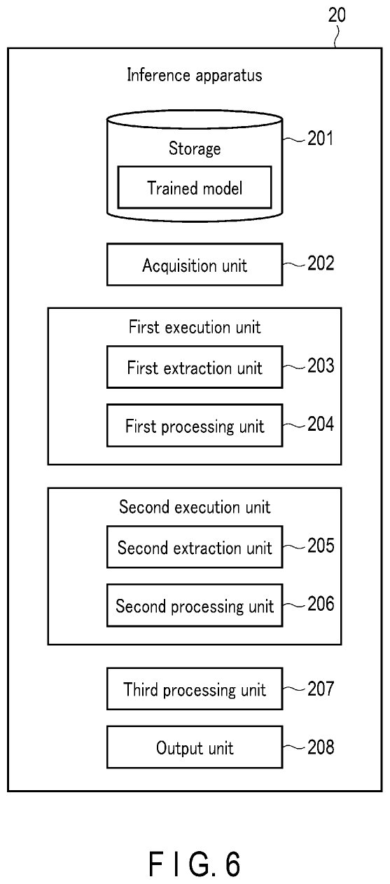

An inference apparatus according to the second embodiment will be described with reference to a block diagram of FIG. 6.

An inference apparatus 20 includes a storage 201, an acquisition unit 202, a first extraction unit 203, a first processing unit 204, a second extraction unit 205, a second processing unit 206, a third processing unit 207, and an output unit 208. The first extraction unit 203 and the first processing unit 204 are collectively referred to as a first execution unit. The second extraction unit 205 and the second processing unit 206 are collectively referred to as a second execution unit.

The storage 201 stores the trained model generated by the learning apparatus 10 according to the first embodiment.

The acquisition unit 202 acquires processing target data to be inferred.

The first extraction unit 203 inputs processing target data to the first network N1 portion of the trained model and extracts first feature values.

The first processing unit 204 executes processing related to a task of the trained model on the first feature values and generates a first processing result. That is, the first execution unit inputs the processing target data to the first network N1 and generates the first processing result.

The second extraction unit 205 inputs processing target data to the second network N2 portion of the trained model and extracts a second feature value.

The second processing unit 206 executes processing related to a task of the trained model on the second feature value and generates a second processing result. That is, the second execution unit inputs the processing target data to the second network N2 and generates the second processing result.

The third processing unit 207 generates an inference result from the first processing result and the second processing result.

The output unit 208 outputs the inference result externally.

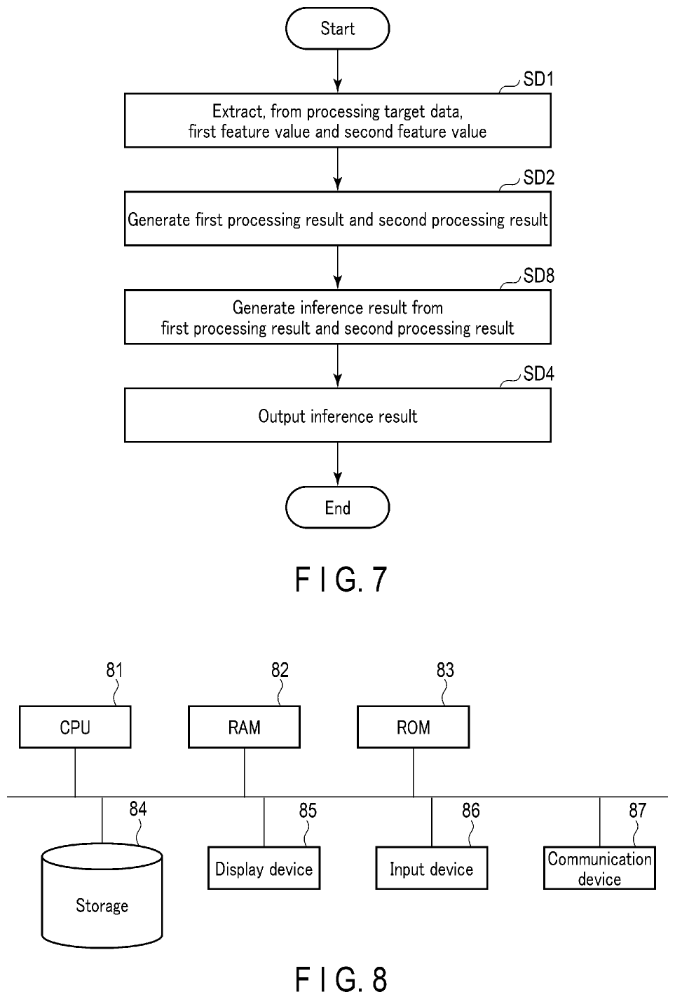

Next, an inference processing of an inference apparatus according to the second embodiment will be described with reference to the flowchart of FIG. 7.

In step SD1, the first extraction unit 203 and the second extraction unit 205 extract, from the processing target data, the first feature values and the second feature value, respectively.

In step SD2, the first processing unit 204 and the second processing unit 206 generate a first processing result and a second processing result, respectively.

In step SD3, the third processing unit 207 generates an inference result from the first processing result and the second processing result. For example, the third processing unit 207 may generate a weighted average of the first processing result and the second processing result as the inference result. Alternatively, the third processing unit 207 may calculate the reliability (uncertainty) based on the difference between the first processing result and the second processing result.

In step SD4, the output unit 208 outputs the inference result externally. For example, the output unit 208 may output the third processing result in a mode that can be recognized by the user, for example, by displaying the third processing result on a display or the like.

Note that the trained model itself may be stored in an external server (not illustrated), and the inference processing may be performed by having the inference apparatus 20 transmit processing target data to the server, and the inference apparatus 20 receive a processing result obtained by inputting the processing target data to the trained model in the external server.

According to the second embodiment described above, by performing inference using the trained model generated in the first embodiment, it is possible to obtain a highly accurate inference result in, for example, an identification task even in a case where data with noise is input. That is, data with unnecessary information can be processed with high accuracy.

Note that, in the above-described embodiments, a convolutional neural network is assumed as a machine learning model, but the present invention is not limited thereto, and any model generally used in the machine learning field, such as a support vector machine, a random forest, and a logistic regression, can be similarly applied.

Next, an example of a hardware configuration of the learning apparatus 10 according to the above-described embodiments is illustrated in a block diagram of FIG. 8. Note that an example of the learning apparatus 10 will be described below, but the inference apparatus 20 may also have a similar hardware configuration.

The learning apparatus 10 includes a central processing unit (CPU) 81 and a random access memory (RAN) 82, a read only memory (ROM) 83, a storage 84, a display device 85, an input device 86, and a communication device 87, which are connected by a bus.

The CPU 81 is a processor that executes arithmetic processing, control processing, and the like according to a program. The CPU 81 uses a predetermined area of the RAM 82 as a work area, and executes processing of each unit of the learning apparatus 10 described above in cooperation with programs stored in the ROM 83, the storage 84, and the like. Alternatively, processing circuitry can be used to execute the processing of each unit of the learning apparatus 10.

The RAM 82 is a memory such as a synchronous dynamic random access memory (SDRAM). The RAM 82 functions as a work area of the CPU 81. The ROM 83 is a memory that stores programs and various types of information in a non-rewritable manner.

The storage 84 is an apparatus that writes and reads data in and from a magnetic recording medium such as a hard disc drive (HDD), a semiconductor storage medium such as a flash memory, a magnetically recordable storage medium such as an HDD, an optically recordable storage medium, or the like. The storage 84 writes and reads data to and from the storage medium under the control of the CPU 81.

The display device 85 is a display apparatus such as a liquid crystal display (LCD). The display device 85 displays various types of information based on a display signal from the CPU 81.

The input device 86 is an input apparatus such as a mouse and a keyboard. The input device 86 receives information input by operation from the user as an instruction signal, and outputs the instruction signal to the CPU 81.

The communication device 87 communicates with an external apparatus via a network in accordance with control from the CPU 81.

The instruction illustrated in the processing procedure described in the above-described embodiment can be executed based on a program that is software. By storing this program in advance and reading this program, a general-purpose computer system can obtain an effect similar to the effect of the control operation of the learning apparatus and the inference apparatus described above. The instructions described in the above-described embodiments are recorded in a magnetic disk (flexible disk, hard disk, etc.), an optical disk (CD-ROM, CD-R, CD-RW, DVD-ROM, DVD±R, DVD±RW, Blu-ray (registered trademark) Disc, and the like), a semiconductor memory, or a recording medium similar thereto as a program that can be executed by a computer. The storage format may be any form as long as it is a recording medium readable by a computer or an embedded system. If the computer reads a program from the recording medium and causes the CPU to execute an instruction written in the program based on the program, it is possible to realize an operation similar to the control of the learning apparatus and the inference apparatus of the above-described embodiment. Of course, in a case where the computer acquires or reads the program, the program may be acquired or read through a network.

In addition, an operating system (OS), database management software, middleware (MW) such as a network, or the like running on a computer based on an instruction of a program installed from a recording medium to the computer or an embedded system may execute a part of each process for realizing the present embodiment.

Furthermore, the recording medium in the present embodiment is not limited to a medium independent of a computer or an embedded system, and includes a recording medium that downloads and stores or temporarily stores a program transmitted via a LAN, the Internet, or the like.

Furthermore, the number of recording media is not limited to one, and a case where the processing in the present embodiment is executed from a plurality of media is also included in the recording media in the present embodiment, and the configuration of the media may be any configuration.

Note that the computer or the embedded system in the present embodiment is for executing each processing in the present embodiment based on a program stored in a recording medium, and may have any configuration such as an apparatus including one of a personal computer, a microcomputer, and the like, a system in which a plurality of apparatus is connected to a network, and the like.

In addition, the computer in the present embodiment is not limited to a personal computer, and includes an arithmetic processing apparatus, a microcomputer, and the like included in an information processing apparatus, and collectively refers to a device and an apparatus capable of realizing a function in the present embodiment by a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising processing circuitry configured to:
extract first feature values from input data by processing based on one or more first parameters;
extract second feature values from the input data by processing based on one or more second parameters different from the first parameters;
generate a first converted feature values and a second converted feature values by stochastically converting at least one of the first feature values and the second feature values;
calculate a first loss related to similarity between the first converted feature values and the second converted feature values;
obtain a first processing result by processing based on one or more third parameters with respect to the first converted feature values, the one or more third parameters being different from the first parameters and the second parameters; and
update a parameter of at least one of the first parameters and the third parameters such that a value based on the first loss and a second loss calculated from the first processing result and a label is minimized.

2. The apparatus according to claim 1, wherein the processing circuitry generates the first converted feature values and the second converted feature values by replacing at least one element of the first feature values and the second feature values selected by a random number with a predetermined value.

3. The apparatus according to claim 1, wherein the processing circuitry generates the first converted feature values and the second converted feature values by (a) adding at least one of the first feature values and the second feature values to a pattern generated based on a random number or (b) multiplying at least one of the first feature values and the second feature values by the pattern.

4. The apparatus according to claim 1, wherein the processing circuitry generates the first converted feature values or the second converted feature values by a weighted average of the first feature values and the second feature values.

5. The apparatus according to claim 1, wherein at least one of first processing and second processing is executed a plurality of times,
the first processing performing processing of generation of the first converted feature values and the second converted feature values after processing of extraction of the first feature values,
the second processing performing processing of the processing of generation of the first converted feature values and the second converted feature values after processing of extraction of the second feature values.

6. The apparatus according to claim 1, wherein the processing circuitry executes preprocessing including one or more conversions on the input data.

7. The apparatus according to claim 1, wherein the processing circuitry is further configured to:
obtain a second processing result by executing processing based on one or more fourth parameters different from the first to the third parameters, with respect to the second converted feature values; and
update a parameter of at least one of the second parameters and the fourth parameters such that a value based on a third loss calculated from the second processing result and a label is minimized.

8. The apparatus according to claim 7, wherein the processing circuitry updates the first parameters and the third parameters after completion of updating of the second parameters and the fourth parameters.

9. The apparatus according to claim 1, wherein the processing circuitry updates the second parameters based on updated first parameters.

10. A learning method, comprising:
extracting first feature values from input data by processing based on one or more first parameters;
extracting second feature values from the input data by processing based on one or more second parameters different from the first parameters;
generating a first converted feature values and a second converted feature values by stochastically converting at least one of the first feature values and the second feature values;
calculating a first loss related to similarity between the first converted feature values and the second converted feature values;
obtaining a first processing result by processing based on one or more third parameters with respect to the first converted feature values, the one or more third parameters being different from the first parameters and the second parameters; and
updating a parameter of at least one of the first parameters and the third parameters such that a value based on the first loss and a second loss calculated from the first processing result and a label is minimized.

11. A non-transitory computer readable medium including computer executable instructions, wherein the instructions, when executed by a processor, cause the processor to perform a method comprising:
extracting first feature values from input data by processing based on one or more first parameters;
extracting second feature values from the input data by processing based on one or more second parameters different from the first parameters;
generating a first converted feature values and a second converted feature values by stochastically converting at least one of the first feature values and the second feature values;
calculating a first loss related to similarity between the first converted feature values and the second converted feature values;
obtaining a first processing result by processing based on one or more third parameters with respect to the first converted feature values, the one or more third parameters being different from the first parameters and the second parameters; and
updating a parameter of at least one of the first parameters and the third parameters such that a value based on the first loss and a second loss calculated from the first processing result and a label is minimized.

12. An inference apparatus using a first network and a second network trained by the learning apparatus according to claim 7, the first network including a parameter group of the first parameters and the third parameters, the second network including a parameter group of the second parameters and the fourth parameters,
the inference apparatus comprising processing circuitry configured to:
input processing target data to the first network and generate a first processing result;
input processing target data to the second network and generate a second processing result; and
calculate at least one of a weighted average of the first processing result and the second processing result and reliability based on a difference between the first processing result and the second processing result.
